(19) United States
(12) Patent Application Publication
(10) Pub. No.: US 2004/0120566 A1
(43) Pub. Date: Jun. 24, 2004

(54) Compact storage of projection matrix for tomography using separable operators

(76) Inventor: David L. Gines, Fort Collins, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/325,331

(22) Filed: Dec. 19, 2002

(51) Int. Cl. G06K 9/00

(52) U.S. Cl. 382/131

(57) ABSTRACT

Disclosed are systems and methods for providing a projection matrix used in tomographic reconstruction of desired images comprising deriving a linear representation of a projection matrix which comprises a product of two functions, and calculating an explicit representation of the projection matrix having separate operators defined by the two functions for the case of an infinitely thin layer approximation.

### CROSS-REFERENCE TO RELATED APPLICATIONS

The present application is related to U.S. patent application Ser. No. ______ (Attorney Docket No. 10020619-1) entitled A SYSTEM AND METHOD FOR PARALLEL IMAGE RECONSTRUCTION OF MULTIPLE DEPTH LAYERS OF AN OBJECT UNDER INSPECTION FROM RADIOGRAPHIC IMAGES, and to U.S. patent application Ser. No. ______ (Attorney Docket No. 10020620-1) entitled IMAGE BUFFERS AND ACCESS SCHEDULES FOR IMAGE RECONSTRUCTION SYSTEMS, and to (Attorney Docket No. 10020713-1) entitled SYSTEMS AND METHODS FOR RECONSTRUCTION OF IMAGES IN COMPRESSED FORMAT, all of which are incorporated herein in their entireties by reference.

### TECHNICAL FIELD

The present invention relates in general to image processing, and more particularly to compact storage of projection matrices for tomographic image reconstruction using separable operators.

### BACKGROUND OF THE INVENTION

It is often desired to construct a cross-section view (layer or slice) and/or three dimensional (3D) view of an object for which actually presenting such views is impossible, such as due to irreparably damaging the object. For example, imaging systems are utilized in the medical arts to provide a view of a slice through a living human's body and to provide 3D views of organs therein. Similarly, imaging systems are utilized in the manufacture and inspection of industrial products, such as electronic circuit boards and/or components, to provide layer views and 3D views for inspection thereof.

Often desired images are provided through reconstruction techniques which use multiple two dimensional (2D) radiographic, e.g., X band radiation (X-ray), images, e.g., detector images. The technique of reconstructing a desired image or view of an object (be it a three-dimensional image, a cross-sectional image, and/or the like) from multiple projections (e.g., different detector images) is broadly referred to as tomography. When such reconstruction of a cross-sectional image is performed with the aid of a processor-based device (or “computer”), the technique is broadly referred to as computed (or computerized) tomography (CT). In a typical example application, a radiation source projects X band radiation through an object onto an electronic sensor array thereby providing a detector image. By providing relative movement between one or more of the object, the source, and the sensor array, multiple views (multiple detector images having different perspectives) may be obtained. An image of a slice through the object or a three-dimensional (“3D”) image of the object may then be approximated by use of proper mathematical transforms of the multiple views. That is, cross-sectional images of an object may be reconstructed, and in certain applications such cross-sectional images may be combined to form a 3D image of the object.

Within X-ray absorption tomography, a number of imaging techniques are applicable to reconstruction of cross-sectional slices. One imaging technique is known as laminography. In laminography, the X-ray source and sensor are moved in a coordinated fashion relative to the object to be viewed so that portions of an object outside a selected focal plane lead to a blurred image at the sensor (see, for example, U.S. Pat. No. 4,926,452). Focal plane images are reconstructed in an analog averaging process. An example of a laminography system that may be utilized for electronics inspection is described further in U.S. Pat. No. 6,201,850 entitled “ENHANCED THICKNESS CALIBRATION AND SHADING CORRECTION FOR AUTOMATIC X-RAY INSPECTION.” An advantage of laminography is that extensive computer processing of ray equations is not required for image reconstruction.

Another imaging technique is known as tomosynthesis. Tomosynthesis is an approximation to laminography in which multiple projections (or views) are acquired and combined. As the number of views becomes large, the resulting combined image generally becomes identical to that obtained using laminography with the same geometry. A major advantage of tomosynthesis over laminography is that the focal plane to be viewed can be selected after the projections are obtained by shifting the projected images prior to recombination. Tomosynthesis may be performed as an analog method, for example, by superimposing sheets of exposed film. Tomosynthesis may, instead, be performed as a digital method. In digital tomosynthesis, the individual views are divided into pixels, and digitized and combined via computer software.

Three-dimensional computed tomography has the potential for more accurate image reconstruction than laminography or tomosynthesis, but at the expense of speed (computation time). Three-dimensional computed tomography is computationally intensive. One approach to three-dimensional computer-aided tomography is to position an X-ray source having a cone-shaped three-dimensional ray output on one side of an object to be viewed, position a two-dimensional array of sensors on the opposite side of the object to be viewed, and synchronously move the source/array relative to the object. There are many suitable scan paths. For example, the source may be moved in orthogonal circles around the object to be viewed, or the source may be moved along a helical path or other path along a cylinder surrounding the object to be viewed. This approach, known as “cone-beam tomography,” is preferable in many cases for reconstructing cross-sectional images, and is potentially preferable for industrial inspection systems (e.g., for electronic assembly analysis) because of the resulting image quality.

Perhaps the best known practical application of X-ray absorption tomography is the medical computerized tomography scanner (CT Scanner, also called computer-aided tomography or computerized axial tomography (CAT)). For instance, cross-sectional image reconstruction from radiographic (e.g., X-ray) images is commonly used in medical applications to generate a cross-sectional image (and/or 3D view) of the human body or part of the human body from an X-ray image. In those applications, speed of reconstruction of the cross-sectional images is typically not very important. However, as medical procedures continue to evolve, certain medical applications are beginning to desire fast reconstruction of cross-sectional images. For instance, real-time X-ray imaging is increasingly being desired by medical procedures, such as many electro-physiologic cardiac procedures, peripheral vascular procedures, percutaneous transluminal catheter angioplasty (PTCA) procedures, urological procedures, and orthopedic procedures, as examples.

Tomography is also of interest in automated inspection of industrial products. For instance, reconstruction of cross-sectional images from radiographic (e.g., X-ray) images has been utilized in quality control inspection systems for inspecting a manufactured product, such as electronic devices (e.g., printed circuit boards). That is, tomography may be used in an automated inspection system to reconstruct images of one or more planes (which may be referred to herein as “layers” or “cross-sections”) of an object under study in order to evaluate the quality of the object (or portion thereof). An X-ray imaging system may create 2-dimensional detector images (layers, or slices) of a circuit board at various locations and at various orientations. Primarily, one is interested in images which lie in the same plane as the circuit board. In order to obtain these images at a given region of interest, raw X-ray detector images may be mathematically processed using a reconstruction algorithm.

For instance, a printed circuit board (or other object under study) may comprise various depth layers of interest for inspection. As a relatively simple example, a dual-sided printed circuit board may comprise solder joints on both sides of the board. Thus, each side of the circuit board on which the solder joints are arranged may comprise a separate layer of the board. Further, the circuit board may comprise surface mounts (e.g., a ball grid array of solder) on each of its sides, thus resulting in further layers of the board. The object under study may be imaged from various different angles (e.g., by exposure to X-rays at various different angles) resulting in radiographic images of the object, and such radiographic images may be processed to reconstruct an image of a layer (or “slice”) of the object. Thereafter, the resulting cross-sectional image(s) may, in some inspection systems, be displayed layer by layer, and/or such cross-sectional images may be used to reconstruct a full 3D visualization of the object under inspection.

In a standard reconstruction algorithm, a projection matrix (a matrix which describes a way in which an object under study is projected onto a detector of an imaging system) is utilized in reconstructing images (e.g., 3D images, layer or slice 2D images, etcetera) from a plurality of detector images. Typically, the detector image data is represented as an array of pixels, where the value of each pixel represents the sampled value of the image at that location. Because of the fine resolution required by an inspection system, the size of the projection matrix used in providing reconstructed images is prohibitive. For example, reconstructing 100 layers of a circuit board using X-ray detectors of 1000×1000 pixels may require a projection matrix that is 10⁸ on each side, and which contains 10¹⁰ elements (numbers). Such a projection matrix is too large to be stored in the memory of a typical micro-computer system, such as a personal or desktop computer (PC).

Because of the large size of the projection matrix, prior solutions typically do not involve storing the projection matrix in computer memory at all. Instead, elements of the projection matrix are computed as needed during operation of reconstruction algorithms. This approach suffers various disadvantages, including loss of computing efficiency, lack of flexibility, and difficulty of analysis. For example, a loss of computing efficiency is experienced due to the necessity to recalculate the projection matrix for each operation of the reconstruction algorithms. Moreover, in an iterative procedure, wherein a reconstruction algorithm utilizes aspects of a projection matrix multiple times, the projection matrix may be recomputed during each iteration. Additionally, to facilitate calculation and recalculation of the projection matrix, the description of the projection matrix is generally “hard-coded” into the algorithm, making it difficult to adapt to changing conditions and thereby providing a lack of flexibility. Also, the lack of flexibility is further exasperated in particular situations as certain solution techniques, such as direct matrix methods including LU or QR factorization and basis transform methods including wavelet transforms, typically cannot be used unless an explicit construction of the projection matrix exists.

Accordingly, there is a need in the art for providing an alternate representation of a projection matrix that can be efficiently stored, such as within PC memory, facilitates computing efficiency, allows for flexibility with respect to reconstruction algorithms, and/or provides advantages in analysis.

### BRIEF SUMMARY OF THE INVENTION

An embodiment of the invention provides a method for providing a projection matrix used in tomographic reconstruction of desired images, the method comprising deriving a projection matrix which comprises a product of two functions, and calculating an explicit representation of the projection matrix having separate operators defined by the two functions for the case of an infinitely thin layer approximation.

A further embodiment of the invention provides a computer program product having a computer readable medium having computer program logic recorded thereon for providing a projection matrix used in tomographic reconstruction of desired images, the computer program product comprising code for deriving a projection matrix having two separable functions, code for calculating an explicit representation of the projection matrix having separate operators defined by the two functions, and code for directly using the explicit representation of the projection matrix by an image reconstruction algorithm to reconstruct a desired image.

A still further embodiment of the invention provides an imaging system comprising a memory storing an explicit representation of a projection matrix having separate operators defined as a function of a product of two functions, and a processor operating under control of an image reconstruction algorithm which uses the explicit representation of the projection matrix and a plurality of detector images to reconstruct a desired image, wherein the processor operates on the projection matrix as a linear combination of separable operators.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in

FIG. 1A shows a detector image such as may be utilized with respect to a projection matrix of the present invention in reconstructing a desired image;

FIG. 1B shows the detector image of FIG. 1 in vector form;

FIG. 2 shows a graphical representation of the operation of a projection matrix and detector image in reconstructing a desired image;

FIG. 3 shows a graphical representation of the operation of the projection matrix of FIG. 2, configured according to the present invention to have separable objects, and a detector image in reconstructing a desired image;

FIGS. 4A-4D show a projection matrix and detail with respect to a block thereof;

FIG. 5 shows a graphical representation of the projection matrix of FIG. 4, configured according to the present invention to have separable objects, as a linear combination of separable operators used in reconstructing a desired image;

FIG. 6 shows a flow diagram of providing a projection matrix according to an embodiment of the present invention; and

FIG. 7 shows an imaging system configured according to an embodiment of the present invention.

### DETAILED DESCRIPTION OF THE INVENTION

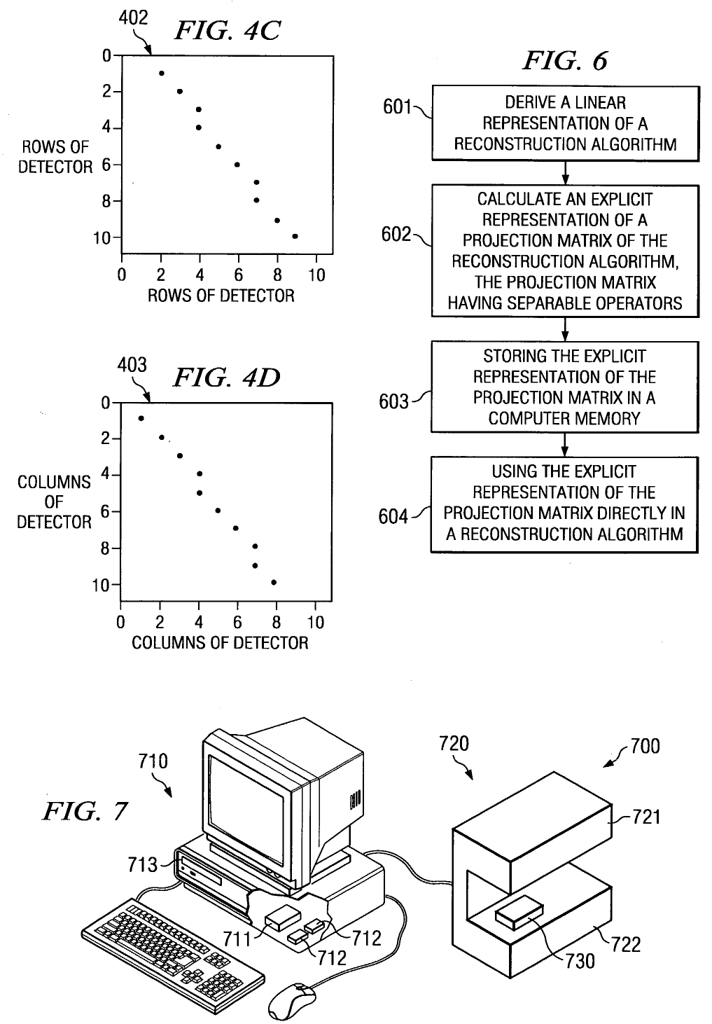

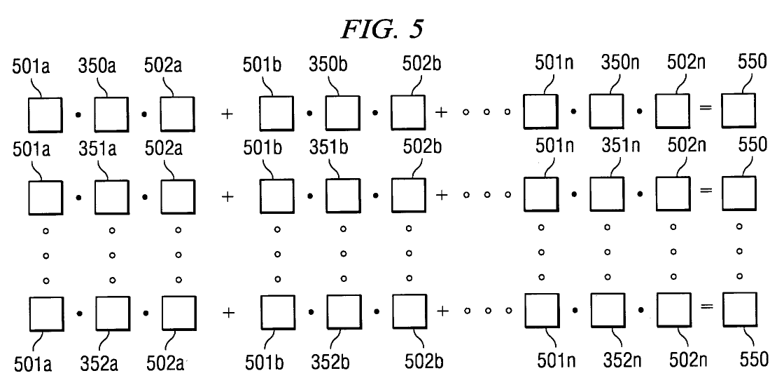

The present invention is directed to systems and methods in which a projection matrix is provided in a compact, preferably “separable”, form. Accordingly, embodiments of the present invention provide projection matrices which require considerably less storage space than those of the prior art, and therefore may be stored ready for use in a relatively inexpensive host system such as a PC. For example, the number of elements stored as a projection matrix of one embodiment of the present invention (see the following discussion with respect to FIGS. 4A-4D and 5) is reduced by a factor of 500 over a projection matrix of the prior art providing the same resolution. In general, the number of elements of a projection matrix may be reduced according to embodiments of the present invention by a factor of N/2, where N is the number of pixels on one side of the detector images used as inputs to the reconstruction algorithm.

It should be appreciated that embodiments of the present invention provide various advantages over prior art solutions, such as flexibility, processing efficiency, and simplified analysis with respect to the projection matrix. For example, using projection matrices configured according to embodiments of the present invention, a wider range of reconstruction algorithm solution techniques are now possible, including direct methods and basis transformations, due to the reconstruction algorithms no longer having to be “hard-coded” to the particular projection matrix used, thereby providing increased flexibility. Explicit construction of the projection matrix also allows, much more easily, alternative representations of an image. Accordingly, instead of a simple, pixel-based representation of an image, many other possible representations, such as piece-wise polynomial representations, may be provided by projection matrices of the present invention. Moreover, embodiments of the present invention allow for improved or simplified analysis and visualization of the projection matrix, which can in turn lead to development of more efficient reconstruction algorithms. Because projection matrices of embodiments of the present invention do not need to be recomputed during image reconstruction, it is expected that operation of such reconstruction algorithms will be accelerated. Moreover, the projection matrices of embodiments of the present invention facilitate efficient operation of iterative image reconstruction procedures, such as those shown and described in the above referenced patent application entitled “SYSTEMS AND METHODS FOR RECONSTRUCTION OF IMAGES IN COMPRESSED FORMAT”.

It should be appreciated that, in addition to various advantages discussed above, projection matrices of embodiments of the present invention resolve issues relating to basis transformations. For example, detector images may be stored in a compressed format, e.g., using a wavelet transform function. In order to operate on such images according to a reconstruction algorithm, the projection matrix may undergo a transformation corresponding to that of the detector image, as shown and described in the above referenced patent application entitled “SYSTEMS AND METHODS FOR RECONSTRUCTION OF IMAGES IN COMPRESSED FORMAT”. Having a fully calculated, explicit representation of the projection matrix facilitates a straightforward application of various transformations.

In providing a compact projection matrix configuration, embodiments of the present invention split the projection matrix into two separate operators, e.g., one which operates only along the x-direction and one that operates only along the y-direction. Under the correct conditions, separation methods employed according to embodiments of the invention effectively find and exploit structure and redundancy in the projection matrix.

Moreover, using the separable operator structure of the above described embodiment, application of transformations, such as those corresponding to a compression transform utilized with respect to detector images as discussed above, is significantly simplified. For example, transformations may need only to be applied in one direction, e.g. to compress the detector image and directly calculate a compressed reconstructed image, which leads to reduced computation time and storage. In an embodiment wherein the projection matrix is split explicitly into x and y components, transformations may be applied separately to the x and y directions. In contrast, typical prior representations of projection matrices are configured such that more complicated transformations, which act simultaneously on x and y directions, are required. Such transformations have higher computational cost, and require more storage.

In understanding compact storage of a projection matrix using separable operators according to embodiments of the present invention, it is helpful to review mathematical representations of the equations that are to be solved in a reconstruction algorithm. A linear model for an X-ray imaging system may be represented as:

bₐ(x, y)=∫f(x, y, z)dt (1)

where bₐ(x,y) is a representation of the known pixel values recorded by the imaging system detectors (detector image) at an angle a, f(x,y,z) is a function which represents the X-ray absorption of the object being imaged, and t when integrated over the differential thereof, is a line which describes the path a single X-ray takes from source to detector (t is a function of a, x, and y).

It is useful to represent f of equation (1) above as a linear combination of basis functions in arriving at a projection matrix using separable operators. Accordingly, f may be represented as the following combinations of basis functions:

$$f ( x , y , z ) = {\sum }_{i}^{} {\sum }_{j}^{} {\sum }_{k}^{} {c}_{ijk} {φ}_{i} ( x ) {φ}_{j} ( y ) {φ}_{k} ( z ) , \qquad ( 2 )$$

where cᵢⱼₖ are unknown coefficients for the absorption function, and are suitable basis functions, such as dirac-delta functions, polynomials, Fourier bases, hierarchical functions, etcetera. Using the linear combinations of basis functions of equation (2), equation (1) can be rewritten as a liner system of equations:

Pc=b (3)

where

Pᵢⱼₖ=∫φᵢ(k)φⱼ(yφₖ(z) (4)

is the projection matrix which describes the way in which an ideal circuit board, or other object under study, images are “projected” onto a detector by an X-ray source.

The type of solution method and the choice of discretization is often interdependent on the choice of basis function. According to embodiments of the present invention, φ(z) may comprise a dirac-delta function as set forth below:

φₖ(z)=δ(z−zₖ) (5)

These functions model the object under study as a series of infinitely thin layers. The matrix P of equation (3) above is separable under this approximation.

Substituting the basis functions of equation (5) in equation (4), the linear system of equation (3) may be rewritten as:

$${b}_{a} ( {x}_{p} , {y}_{q} ) = {\sum }_{k}^{} [ {\sum }_{i}^{} {φ}_{i} ( {x}_{m} ) ] [ {\sum }_{j}^{} {φ}_{j} ( {y}_{m} ) ] {c}_{ijk} , \qquad ( 6 )$$

where xₘ and yₘ are locations on infinitely thin planes which are projected onto xₚ and y_{q}.

It should be appreciated that the right hand side of equation (6) above sets forth a sum over k of the product of two functions. Specifically, the two functions are denoted by square brackets ([ ]*[ ]) such that a separable projection matrix, P, comprises Px (Px in the illustrated embodiment represented by [Σφᵢ(xₘ)]) and Py (Py in the illustrated embodiment represented by [Σφⱼ(yₘ)]). It is the separation of these two terms, one a function of x (Px), and the other a function of y (Py), which facilitates a separable representation. Note that in general a separable representation is not possible with respect to equation (4) above, since the product of the integrals does not equal the integral of the products.

Having shown in detail the mathematical representations of the equations that are to be solved in a reconstruction algorithm, the above concepts will be further discussed with respect to a graphical example to help clarify concepts of embodiments of the present invention. The following graphical example helps show how a projection matrix may be collapsed by representing the x and y directions separately.

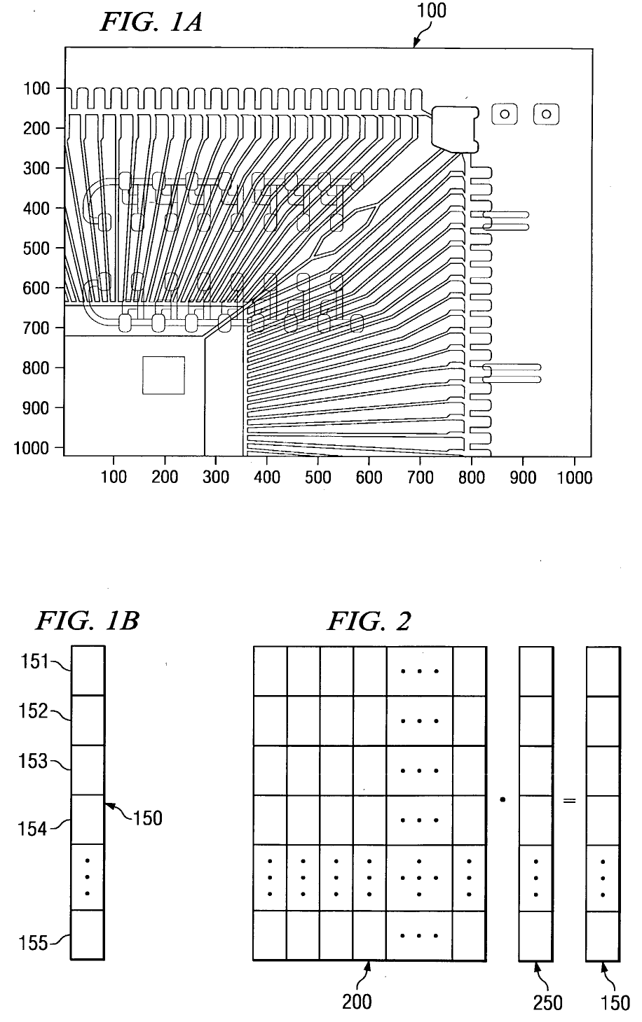

In order to demonstrate the structure of a projection matrix according to embodiments of the present invention, it is convenient to first represent detector images as vectors. Directing attention to FIGS. 1A and 1B, a detector image and corresponding image vector are shown. Detector image 100 of FIG. 1A represents a raw detector image, as may be taken using a 5DX X-ray imaging system available from Agilent Technologies. Detector image vector 150 of FIG. 1B represents the image of FIG. 1A in vector form. For example, vector, block or element 151 represents a first row of image pixels from image 100, vector, block or element 152 represents a second row of image pixels from image 100, and so on with respect to vector elements 153-155.

The linear system, with a projection matrix described mathematically above, is graphically represented in FIG. 2. Specifically, projection matrix 200 of FIG. 2 represents projection matrix P, reconstructed image vector 250 represents f, and detector image vector 150 represents b (each of P, f, and b being of the mathematical representation discussed above). The rows and columns of projection matrix 200 correspond to the x and y directions and, therefore, the size of the projection matrix is proportional to the square of the size of the image it is operating upon.

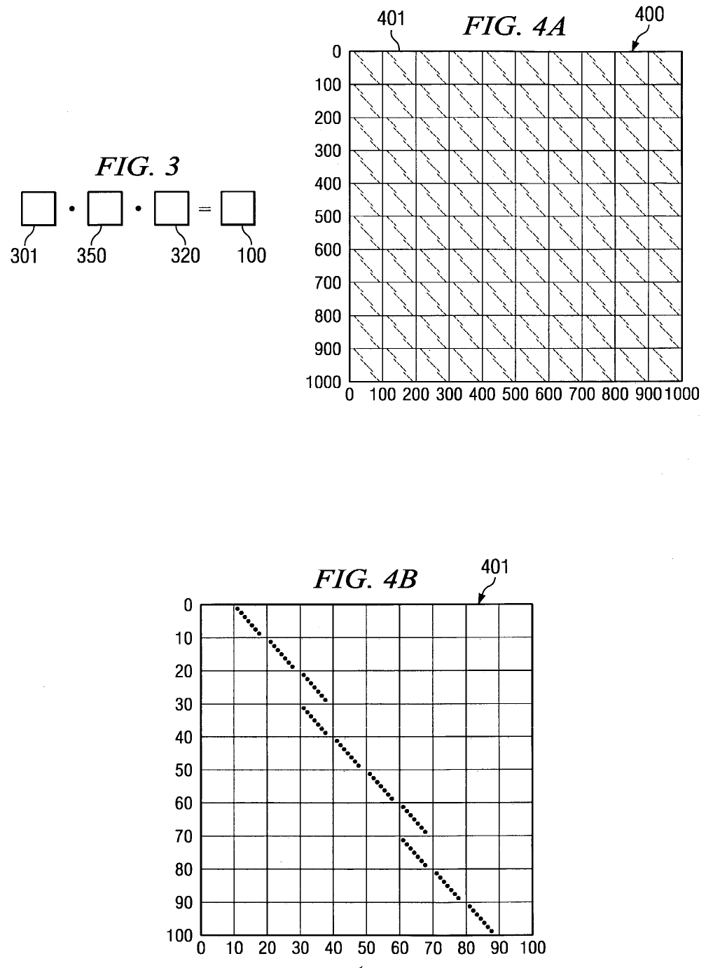

Using a separable structure with respect to the projection matrix, as described above, the linear system in FIG. 2 may be replaced by a much smaller structure. Directing attention to FIG. 3, a compact, separable version of the linear system of FIG. 2 according to an embodiment of the present invention is shown. Specifically, the projection matrix of FIG. 3 is separable as vector 301 (Px) and vector 302 (Py), with matrix 350 being the matrix form of vector 250. Accordingly, the linear system in FIG. 3 is much smaller than the linear system in FIG. 2, yet it is algebraically equivalent.

It should be appreciated that the projection matrix discussed above with respect to FIG. 3 provides reconstruction of a 2D image, such as a layer or slice view of an object under study. However, the concepts of the present invention are also applicable to providing reconstruction of 3D images. A projection matrix using separable operators according to an embodiment of the present invention for reconstructing 3D images is graphically represented in FIG. 5.

According to embodiments of the present invention, the projection matrix for an X-ray imaging system for circuit board inspection, or other object under study, is a 3D operator. The projection matrix can be thought of, however, as a collection of many 2D matrices. As an example, projection matrix 400 of FIG. 4A was constructed for a small 3D system wherein the image detector has a 10×10 pixel array, the object under study is a circuit board divided into 10 layers, and X-ray images are taken from 10 different angles (10 different detector images available for 3D image reconstruction).

Magnifying one of the blocks of projection matrix 400, e.g., block 401, it becomes apparent that all of the non-zero sub-blocks thereof have identical structure, as shown in FIG. 4B. Recognizing that the non-zero sub-blocks have identical structure facilitates the use of a separable representation, such as that discussed above with respect to FIG. 3. Accordingly, we may denote a matrix which contains the location of each non-zero sub-block in FIG. 4B, as shown in FIG. 4C, and a matrix which contains the structure that is repeated in each block, as shown in FIG. 4D.

As the block matrices of FIGS. 4C and 4D are separable, 3D projection matrix 400 may be represented as a linear combination of separable operators according to an embodiment of the present invention. FIG. 5 provides a graphical representation of the 3D projection matrix of FIG. 4 represented as a linear combination of separable operators shown as matrices 501a-501n (Px matrices) and matrices 502a-502n (Py matrices). It should be appreciated that the blocks of Px and Py as well as the various matrices Px and Py are not all necessarily the same. Many, however, may be the same, which can lead to greater compactness.

Matrices 350a-350n, 351a-351n, and 352a-352n of FIG. 5 represent the different detector images that are being processed. Matrices 550 represents the 3D image reconstructed from the detector images using the projection matrix of the illustrated embodiment.

It should be appreciated that, as with the embodiment discussed above with respect to FIG. 3, all of the standard matrix operations (multiplication, transpose, etc.) can be applied to the projection matrix in the form shown in FIG. 5. Similarly, although the linear system of FIG. 5 occupies much less space, and can lead to greater computational efficiency, it is algebraically equivalent to that in FIG. 4.

Directing attention to FIG. 6, a method for providing a projection matrix used in reconstructing desired images according to an embodiment of the present invention is shown. At step 601, a linear representation of a reconstruction algorithm is derived, wherein a projection matrix thereof comprises a product of two functions as discussed above with respect to equation (6). Thereafter, at step 602 an explicit representation of the projection matrix, having separate operators defined by the aforementioned two functions, is calculated as is represented in FIGS. 3 and 5. It should be appreciated that, in addition to the separate operators of the projection matrix presenting a form reduced in size over that of a typical projection matrix, embodiments of the present invention may implement compression techniques with respect thereto, such as using a wavelet or other compression transform or combination of compression transforms.

According to preferred embodiments of the present invention, the resulting projection matrix is compact and, therefore, may be stored in its fully calculated, explicit form in the memory of a computer, such as the memory of a PC. Accordingly, step 603 of the illustrated embodiment stores the explicit representation of the projection matrix in a computer memory. The aforementioned computer memory may be part of an imaging system such that, at step 604, the imaging system directly uses the explicit representation of the projection matrix in an image reconstruction algorithm to reconstruct a desired image.

Directing attention to FIG. 7, an imaging system configured according to an embodiment of the present invention to calculate, store, and/or utilize a projection matrix of the present invention is shown. Specifically, imaging system 700, comprising PC 710 and image transducer 720, is shown. PC 710 of the illustrated embodiment comprises central processing unit (CPU) 711, such as may be a processor based upon the INTEL PENTIUM family of processors or other suitable processor platform, operable under control of an instruction set defining operation as described herein. The instruction set, preferably including an image reconstruction algorithm useful with a projection matrix of the present invention, may be stored by PC 710 in memory 713, such as may comprise a bulk memory (e.g., hard disk drive, optical disk drive, floppy disk drive, etcetera), and/or memory 712, such as may comprise memory having relatively fast access times (e.g., random access memory, read only memory, etcetera). Preferably, a projection matrix of the present invention is additionally or alternatively stored in a memory of PC 710, such as memory 712 and/or 713. Detector images of object 730, such as may be provided by emitter 721 and detector 722 of image transducer 720, may also be stored in a memory of PC 710 for use with a projection matrix of the present invention in reconstructing a desired image.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for providing a projection matrix used in tomographic reconstruction of desired images, said method comprising:
deriving a linear representation of a projection matrix which comprises a product of two functions; and
calculating an explicit representation of the projection matrix having separate operators defined by said two functions for the case of an infinitely thin layer approximation.

2. The method of claim 1, further comprising:
storing said explicit representation of the projection matrix in a computer memory; and
directly using said explicit representation of the projection matrix by an image reconstruction algorithm to reconstruct a desired image.

3. The method of claim 2, wherein said directly using said explicit representation of the projection matrix comprises forming a linear combination of said separable operators.

4. The method of claim 1, further comprising:
compressing said explicit representation of the projection matrix using a compression transform corresponding to a compression transform of a detector image.

5. The method of claim 4, wherein said compression transform comprises a wavelet transform.

6. The method of claim 1, wherein said linear representation is discretized using dirac-delta functions.

7. The method of claim 1, wherein said projection matrix is a two dimensional projection matrix.

8. The method of claim 1, wherein said projection matrix is a three dimensional projection matrix.

9. The method of claim 1, wherein said two functions are determined by recognizing blocks of said projection matrix having identical structure.

10. The method of claim 1, wherein said two functions comprise a first function having information with respect to non-zero blocks in said projection matrix and a second function having information with respect to a pattern of information in a plurality of said non-zero blocks.

11. The method of claim 1, wherein said two functions operate with respect to orthogonal axes of said projection matrix.

12. A computer program product having a computer readable medium having computer program logic recorded thereon for providing a projection matrix used in tomographic reconstruction of desired images, said computer program product comprising:
code for deriving a projection matrix having two separable functions;
code for calculating an explicit representation of the projection matrix having separate operators defined by said two functions; and
code for directly using said explicit representation of the projection matrix by an image reconstruction algorithm to reconstruct a desired image.

13. The computer program product of claim 12, further comprising:
code for compressing said explicit representation of the projection matrix using a compression transform corresponding to a compression transform of a detector image.

14. The computer program product of claim 12, wherein said projection matrix is a two dimensional projection matrix.

15. The computer program product of claim 12, wherein said projection matrix is a three dimensional projection matrix.

16. The computer program product of claim 12, wherein said code for calculating said explicit representation of the projection matrix comprises:
code for recognizing blocks of said projection matrix having identical structure.

17. The computer program product of claim 16, wherein said code for calculating said explicit representation of the projection matrix further comprises:
code for calculating a first function of said two functions having information with respect to non-zero blocks in said projection matrix and a second function of said two functions having information with respect to a pattern of information in a plurality of said non-zero blocks.

18. An imaging system comprising:
a memory storing an explicit representation of a projection matrix having separate operators defined as a function of a product of two functions; and
a processor operating under control of an image reconstruction algorithm which uses said explicit representation of said projection matrix and a plurality of detector images to reconstruct a desired image, wherein said processor operates on said projection matrix as a linear combination of separable operators.

19. The system of claim 18, wherein said explicit representation of said projection matrix is a function of a compression technique applied to an uncompressed form of projection matrix, wherein said plurality of detector images are a function of said compression technique applied to an uncompressed form of detector images, and wherein said desired image is reconstructed in a compressed form directly from said projection matrix and said plurality of detector images.
